(19) United States
(12) Patent Application Publication
(10) Pub. No.: US 2010/0185972 A1
(43) Pub. Date: Jul. 22, 2010

(54) PORTABLE DEVICE FOR POOL OPERATION MANAGEMENT

(76) Inventor: Trevor SHERWOOD, II, Brick, NJ (US)

Correspondence Address: Diane Dunn McKay, Esq.;Mathews, Shepherd, McKay & Bruneau, P.A., Suite 201, 29 Thauet Road, Princeton, NJ, 08540, US

(21) Appl. No.: 12/356,913

(22) Filed: Jan. 21, 2009

(51) Int. Cl. G06F 15/02; G06F 3/00; G06F 3/048

(52) U.S. Cl. 715/780; 708/132; 708/130; 715/810

(57) ABSTRACT

The present invention relates to a portable device for pool operation management. The portable device can be used for determining basic mathematical calculations, pool surface area, pool volume, chemical adjustments and breakpoint superchlorination from measured and entered inputs. In one embodiment, the device includes and LCD display for entering inputs and displaying results. The portable device and also include input devices of a ten digit keypad (0-9), decimal point key, math operation keys (+, −, ×, ÷), mode key, directional arrow keys, on/clear key, enter key and back key.

### BACKGROUND OF THE INVENTION

1. Field of the Invention

The present invention relates to a portable handheld device for entering data and determining calculations for a pool selection and pool operation management.

2. Description of Related Art

It is typical to treat pool water with treatment chemicals to kill/control unhealthy organisms, such as algae, pathogenic bacteria and fungi. Pools are generally treated with chlorine-containing sanitizers so as to contain free available chlorine (FAC) in amounts of from 1 to 3 parts of FAC per million parts of water (ppm). Free available chlorine (FAC) can be established in an aqueous system by adding regularly a source of hypochlorous acid (HOCl) or hypochlorite anion (ClO⁻), e.g., calcium hypochlorite, to the water comprising the aqueous system.

Hypochlorous acid or hypochlorite anion can be introduced into water to be sanitized by passing the water, or a portion thereof, through a container that contains calcium hypochlorite, e.g., calcium hypochlorite in the form of granules, tablets or other shaped forms. Alternatively, calcium hypochlorite, calcium hypochlorite, e.g., granular calcium hypochlorite, can be added directly to water that is to be treated, e.g., sanitized. When water is introduced into the container containing the calcium hypochlorite, it dissolves, thereby forming an aqueous solution comprising hypochlorite anion, which solution is mixed with the water to be treated.

Periodic batch additions of higher levels of hypochlorite anion can be made to the body of water in addition to the relatively steady and lower level additions described previously. Such batch additions of higher levels of hypochlorite anion are commonly referred to as a “shock treatment” or as “superchlorination” and are made on a periodic basis, e.g., once a week, once a month, or as required by problems or conditions arising in the pool or spa, such as high bather loads, algae blooms, high rainfall, fecal release accidents, and the like. The purpose of a shock treatment is to briefly increase the FAC of the water to, e.g., 5 to 20 mg/L, to consume accumulated organic material, destroy chloramines and/or control algae blooms or pathogen infestations. A shock treatment is administered by, for example, preparing a concentrated aqueous solution of calcium hypochlorite and adding this concentrated solution to the water, or distributing, e.g., broadcasting, an appropriate amount of particulate calcium hypochlorite directly over the surface of the water.

The amounts of chemicals to be added are typically calculated manually by a user or pool service company. It is desirable to provide a portable device for entering data and determining calculations for chemical treatment during pool operation management.

### SUMMARY OF THE INVENTION

The present invention relates to a portable device for pool operation management. The portable device can be used for determining basic mathematical calculations, pool surface area, pool volume, chemical adjustments and breakpoint superchlorination from measured and entered inputs. In one embodiment, the device includes an LCD display for entering inputs and displaying results. The portable device and also include input devices of a ten digit keypad (0-9), decimal point key, math operation keys (+, −, ×, ÷), mode key, directional arrow keys, on/clear key, enter key and back key.

A data collection template can be displayed on the device to provide a user interface for collecting and displaying data. The data collection template can comprise consecutive questions nested in menus or submenus, data collection prompts and commands for guiding a user through data collection activities and displaying results.

The invention will be more fully described by reference to the following drawings.

### BRIEF DESCRIPTION OF THE DRAWINGS

FIG. 1 is a schematic diagram of a portable device for pool operation management in accordance with the teachings of the present invention.

FIG. 2 is a schematic diagram of a screen display in a surface area calculation mode.

FIG. 3 is a schematic diagram of a screen display in a volume calculation mode.

FIG. 4 is a schematic diagram of a screen display in a pool operation management mode.

FIG. 5 is a schematic diagram of a screen display in a breakpoint superchlorination mode.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

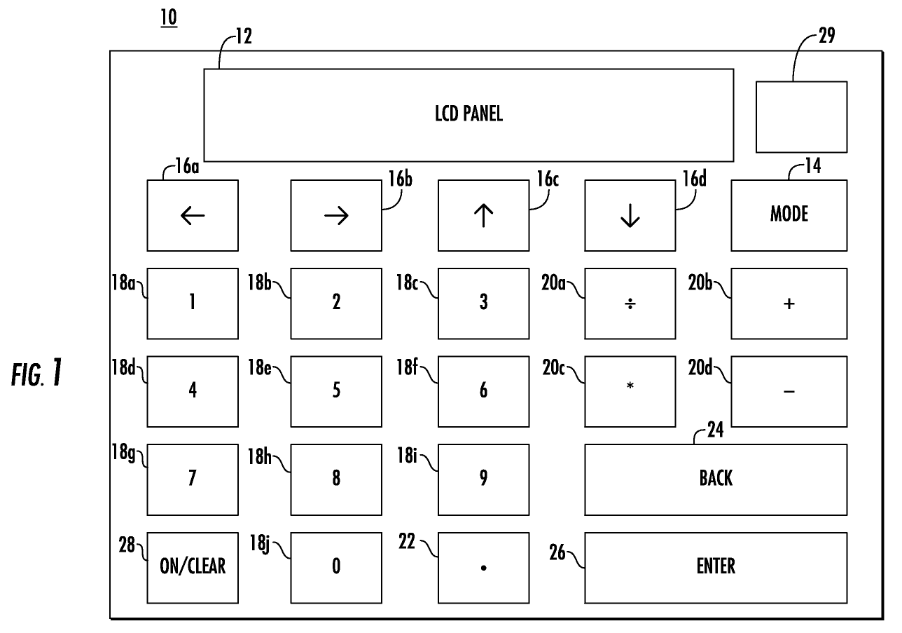

FIG. 1 is a schematic diagram of portable device for pool operation management 10 in accordance with the teachings of the present invention. Portable device for pool operation management 10 can be a handheld device. Portable device for pool operation management 10 can be either solar powered or battery-operated. Display 12 displays information 13 of one or more of inputted entry values, menus and result values in a data collection template. In one embodiment, display 12 is a liquid crystal display (LCD). A suitable display 12 can be a LCD touch screen display.

Mode selection key 14 is used for selecting a mode of operation of portable device for pool operation management 10 as described below. Directional arrow keys 16a-16d are used for moving or scrolling in a respective direction of right, left, up or down, through information 13 displayed on display 12.

Numeric keys 18a-18j are used to input numeric values. Mathematical operation keys 20a-20d are used to input a respective mathematical operator of division, addition, multiplication and subtraction. Decimal point key 22 is used to enter decimal point values during input of numeric values. Back key 24 is used to erase a previous entry of information displayed on display 12. Enter key 26 is used to finish an entry and begin a desired process or to obtain the result of previously entered operations. On/Clear key 28 is used for powering on and off portable device for pool operation management 10. Processor 29 can be used for receiving input, performing calculation operations and forwarding output to be displayed on display 12.

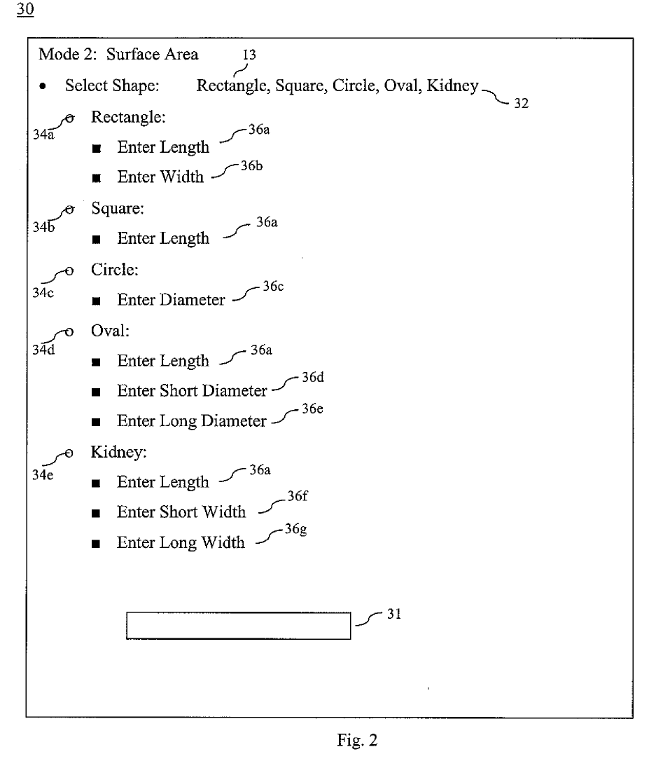

In one embodiment, mode 1 is used as a basic calculation mode in which conventional calculations can be performed by processor 29 based on input from depressing of mathematical operator keys 20a-20d. Mode 2 is used for performing surface area calculations of a housing for a body of water, such as a pool or hot tub. The surface area calculator is used for determining surface area used in many pool related calculations. For example, the surface area can be used in calculations for volume, bather load, cover sizing, heater sizing and the like. Information 13 related to mode 2 can be displayed in a data collection template of one or more screen displays or menus on display 12. An example menu 30 is shown in FIG. 2. In menu item 32, information 13 is displayed to select a shape, such as, for example, rectangle, square, circle, oval and kidney, from items 34a-34e. Upon selection of items 34a-34e, one or more of entry value requests 36a-36g are displayed. Entry value requests are from various dimensions of the housing of a body of water. Numeric keys 18a-18j and decimal key 22, shown in FIG. 1, are used for inputting the requested entry values. For example, if the shape selected with item 34a is a rectangular shape, entry value requests of enter length 36a and enter width 36b are displayed. If the shape selected with item 34b is a square shape, entry value requests of enter length 36a is displayed. If the shape selected with item 34c is a circle shape entry value requests of enter diameter 36c is displayed. If the shape selected with item 34d is an oval shape entry value requests of enter length 36a, enter short diameter 36d and enter long diameter 36e are displayed. If the shape selected with item 34e is a kidney shape entry value requests of enter length 36a, enter short width 36f and enter long width 36f are displayed. Upon entry of the items of the entry value requests from menu 30 a surface area is calculated using processor 29 for the selected shape and the result is displayed in window 31.

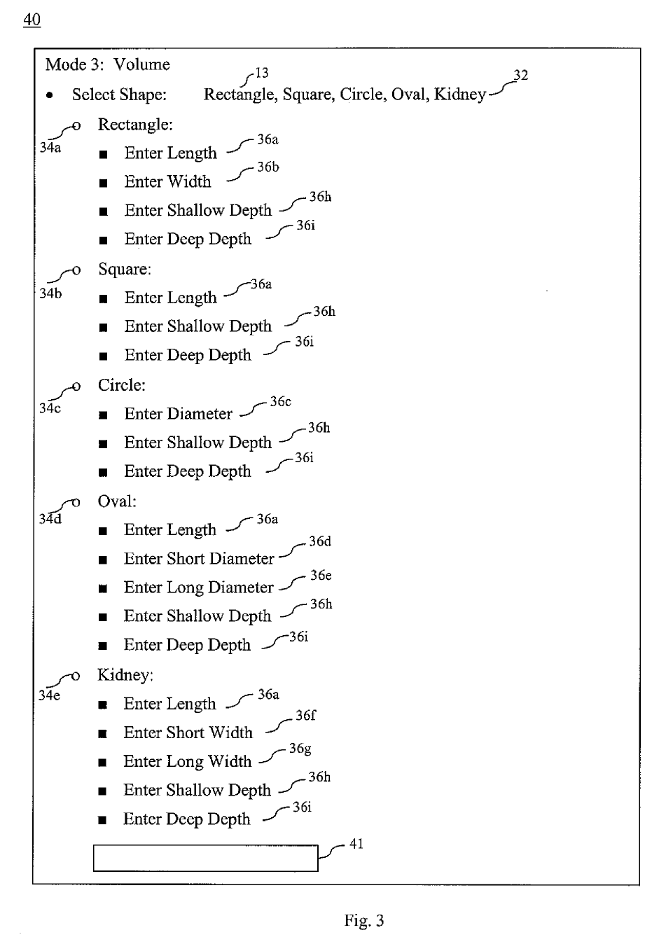

Mode 3 is used for determining the volume of a housing for a body of water. Information 12 related to mode 3 can be in a data collection template of one or more screen displays or menus on display 12. An example menu 40 is shown in FIG. 3. In menu item 32, information 13 is displayed to select a shape, such as, for example, rectangle, square, circle, oval and kidney, from items 34a-34e. Upon selection of items 34a-34e, one or more of entry value requests 36a-36i are displayed. Numeric keys 18a-18j and decimal key 22, as shown in FIG. 1, are used for inputting the requested entry values. For example, if the shape selected with item 34a is a rectangular shape, entry value requests of enter length 36a, enter width 36b, enter shallow depth 36h and enter deep depth 36i are displayed. If the shape selected with item 34b is a square shape, entry value requests of enter length 36a, enter shallow depth 36h, and enter deep depth 36i are displayed. If the shape selected with item 34c is a circle shape entry value requests of enter diameter 36c, enter shallow depth 36h and enter deep depth 36i are displayed. If the shape selected with item 34d is an oval shape, entry value requests of enter length 36a, enter short diameter 36d, enter long diameter 36e, enter shallow depth 36h and enter deep depth 36i are displayed. If the shape selected with item 34e is a kidney shape, entry value requests of enter length 36a, enter short width 36f, enter long width 36g, enter shallow depth 36h and enter deep depth 36i are displayed. Upon entry of the items of entry value requests from menu 40 a value is calculated for the selected shape and displayed in window 41.

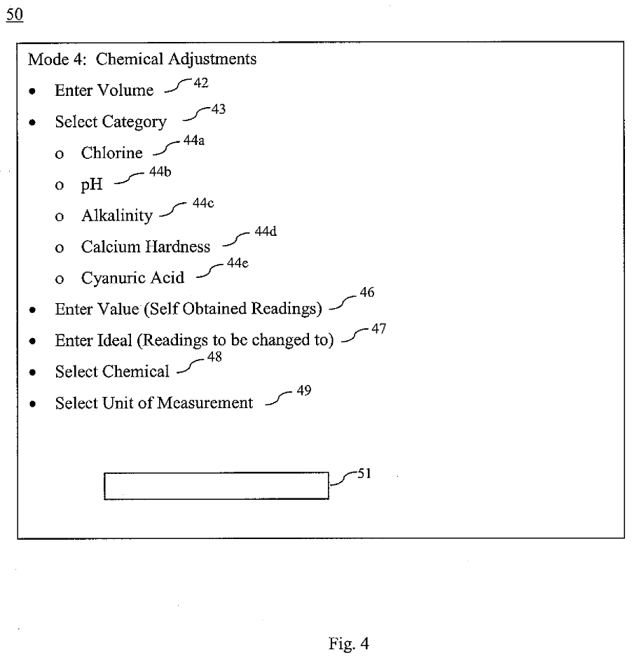

Mode 4 is used for pool operation management for determining memory values for using processor 29 adjustment of chemicals. Information 13 related to mode 4 can be a data collection template of in one or more screen displays or menus on display 12. An example menu 50 is shown in FIG. 4. A display of an entry value request of enter volume 42 is displayed. A value for the volume can be the value determined from mode 3. Alternatively, a new value for the volume can be inputted by the user. In menu item 43, information 13 is displayed for entry volume, to select a category of chemicals or additives to be adjusted, such as, for example, chlorine, pH, alkalinity, calcium hardness, cyanuric acids from items 44a-44e. An entry value request of enter value of self obtained readings 46 can be displayed. The user can enter self obtained readings from water tested for the body of water. An entry value request of enter an ideal reading 47 can be displayed. The user can enter the ideal reading desired to be obtained. An entry value request of select chemical 48 can be displayed. The user can select a chemical or additive to be used for the pool operation management chemical adjustment. An entry value request of select unit of measurement 49 can be displayed. The user can select a unit of measurement to be used for the chemical adjustments. After entry of the items of the entry value requests from menu 50 an amount of a chemical adjustment for a selected chemical is calculated by processor 29 for the selected shape and is displayed in window 51.

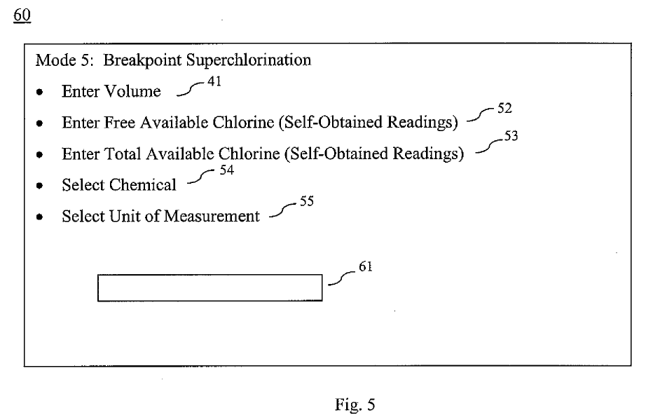

Mode 5 is used for pool operation management for determining one or more values for adjustment of superchlorination. Information related to mode 5 can be in a data collection template of one or more screen displays or menus on display 12. An example menu 60 is shown in FIG. 5. A display of an entry value request of enter volume 42 is displayed. An entry value request of enter free available chlorine of self-obtained readings 52 can be displayed. The user can enter self-obtained readings for free available chlorine. An entry value request of enter total available chlorine of self-obtained readings 53 can be displayed. The user can enter self-obtained readings for total available chlorine. An entry value request of select chemical 54 can be displayed. The user can select a chemical or additive to be used for pool operation adjustment. Suitable types of chlorine which can be selected include sodium hypochlorite (liquid chlorine) or calcium hypochlorite (granular chlorine), lithium hypochlorite, trichlor or dichlor. An entry value request of select unit of measurement 55 can be displayed. The user can select a unit of measure to be used for the superchlorination adjustments. After entry of the items of the entry value requests from menu 60 an amount of superchlorination adjustment for a selected chemical is calculated for the selected shape and is displayed in window 61.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A portable device for operation management of a housing for a body of water comprising:
a display for displaying a data collection template;
means for entering input values into said data collection template;
means for calculating from said input values a result value related to pool operation management; and
means for displaying said result value on said display.

2. The system of claim 1 wherein said means for entering input values comprises a plurality of numeric keys to input numeric values.

3. The portable device of claim 1 wherein said means for entering input comprises a mode selection key for selecting a mode of operation of said portable device.

4. The portable device of claim 3 wherein said mode of operation is a surface area calculator for determining a surface area of the housing for a body of water and said data template includes one or more menus having menu items of dimensions of the housing for a body of water.

5. The portable device of claim 3 wherein said mode of operation is a volume area calculation for determining a value of the housing for a body of water and said data template includes one or more menus having menu items of dimensions of the housing for a body of water.

6. The portable device of claim 3 wherein said mode of operation is a chemical adjustment calculation for determining one or more values of chemical adjustments of the housing for a body of water and said data template includes one or more menus having menu items of dimensions of the housing for a body of water.

7. The portable device of claim 6 wherein said menu items include a category of chemicals or additives to be adjusted from one or more of chlorine, pH, alkalinity, calcium hardness and cyanuric acid.

8. The portable device of claim 7 wherein said menu items include an enter value request to enter an ideal reading.

9. The portable device of claim 8 wherein said menu items include an enter value request to enter a self-obtained reading.

10. The portable device of claim 9 wherein said menu items include an enter value request to select a unit of measurement.

11. The portable device of claim 3 wherein said mode of operation is an adjustment of superchlorination calculation for determining one or more values of chemical adjustments in superchlorinations of the housing for a body of water and said data template includes one or more menus having menu items of dimensions of the housing for a body of water.

12. The portable device of claim 10 wherein said menu items include an entry value request of self-obtained readings for available chlorine.

13. The portable device of claim 10 wherein said menu items include an entry value request of chemical additives to be used for adjustment.

14. The portable device of claim 13 wherein said menu items include an enter value request to select a unit of measurement.

15. The portable device of claim 1 wherein said display is a LCD display.

16. The portable device of claim 1 wherein said housing is a pool or hot tub.

17. A method for operation management of a housing for a body of water comprising:
providing a portable device including a display for displaying a data collection template;
entering input values into said data collection template;
calculating from said input values a result value related to pool operation management; and
displaying said result value on said display.

18. The portable device of claim 17 wherein said step of entering input comprises a mode selection key for selecting a mode of operation of said portable device.

19. The method of claim 17 wherein said mode of operation is a surface area calculator for determining a surface area of the housing for a body of water and said data template includes one or more menus having menu items of dimensions of the housing for a body of water.

20. The method of claim 17 wherein said mode of operation is a volume area calculation for determining a value of the housing for a body of water and said data template includes one or more menus having menu items of dimensions of the housing for a body of water.

21. The portable device of claim 17 wherein said mode of operation is a chemical adjustment calculation for determining one or more values of chemical adjustments of the housing for a body of water and said data template includes one or more menus having menu items of dimensions of the housing for a body of water.

22. The method of claim 21 wherein said menu items include a category of chemicals or additives to be adjusted from one or more of chlorine, pH, alkalinity, calcium hardness and cyanuric acid.

23. The method of claim 22 wherein said menu items include an enter value request to enter an ideal reading.

24. The method of claim 23 wherein said menu items include an enter value request to enter a self-obtained reading.

25. The method of claim 24 wherein said menu items include an enter value request to select a unit of measurement.

26. The method of claim 19 wherein said mode of operation is an adjustment of superchlorination calculation for determining one or more values of chemical adjustments in superchlorinations of the housing for a body of water and said data template includes one or more menus having menu items of dimensions of the housing for a body of water.

27. The method of claim 26 wherein said menu items include an entry value request of self-obtained readings for available chlorine.

28. The method of claim 26 wherein said menu items include an entry value request of chemical additives to be used for adjustment.

29. The method of claim 26 wherein said menu items include an enter value request to select a unit of measurement.
